(19) United States
(12) Patent Application Publication
(10) Pub. No.: US 2026/0270176 A1
(43) Pub. Date: Sep. 10, 2026

(54) NETWORK STATE ESTIMATION APPARATUS, NETWORK STATE ESTIMATION SYSTEM, AND NETWORK STATE ESTIMATION METHOD

(71) Applicant: NEC Corporation, Minato-ku, Tokyo (JP)

(72) Inventors: Anan SAWABE, Tokyo (JP); Yusuke Shinohara, Tokyo (JP); Takanori Iwal, Tokyo (JP)

(73) Assignee: NEC Corporation, Minato-ku, Tokyo (JP)

(21) Appl. No.: 18/714,237

(22) PCT Filed: Dec. 23, 2021
(86) PCT No.: PCT/JP2021/047954

§ 371 Date: May 29, 2024

(51) Int. Cl. H04L 43/0864

(52) U.S. Cl. CPC H04L 43/0864

(57) ABSTRACT

An apparatus includes: an acquisition unit configured to acquire an RTT of each of a first received packet and a second received packet received via a network; a calculation unit configured to calculate an RTT difference that is a difference between the RTT of the first received packet and the RTT of the second received packet; a filtering unit configured to perform Kalman filtering on the RTT difference by using a plurality of stages of Kalman filters connected in series with each other; a specifying unit configured to specify a threshold for an output of a final stage of Kalman filter on the basis of an output of a first stage of Kalman filter; and a estimation unit configured to compare the output of the final stage of Kalman filter with the specified threshold and to estimate a state of the network on the basis of the comparison result.

### TECHNICAL FIELD

The present disclosure relates to a network state estimation apparatus, a network state estimation system, and a network state estimation method.

### BACKGROUND ART

In recent years, there is an increasing demand for remote monitoring or remote control of objects such as robots, machine tools, and cameras. The remote monitoring or the remote control has a characteristic that communication is frequently performed between an operation side and an object. Therefore, in order to appropriately perform remote monitoring or remote control, it is necessary to estimate a state of a network used for communication in real time and robustly.

Therefore, recently, a technique for estimating the state of the network in real time and robustly has been proposed. As an example, there is a technology called Google Congestion Control (GCC) disclosed in Non Patent Literature 1.

The GCC disclosed in Non Patent Literature 1 uses Round-Trip-Time (RTT) in the network as an input, and estimates the state (increase, decrease, or stability) of the queue of the bottleneck link. Hereinafter, the “state of the queue of a bottleneck link” is simply referred to as an RTT state (or a state of an RTT). At this time, since the RTT fluctuates greatly, the GCC performs smoothing by using a Kalman filter. In addition, the GCC estimates whether the state of the RTT is increased, decreased, or stable by using a threshold.

### CITATION LIST

### Non Patent Literature

Non Patent Literature 1: Gaetano Carlucci et al., “Analysis and Design of the Google Congestion Control for Web Real-time Communication (WebRTC)”,
Proceedings of the 7th International Conference on Multimedia Systems, May 2016, Article No. 13, Pages 1 to 12

### SUMMARY OF INVENTION

### Technical Problem

However, the GCC disclosed in Non Patent Literature 1 has a problem that the estimation accuracy is not stabilized although the state of the RTT can be estimated at high speed.

Hereinafter, the above-described problem will be described with reference to FIG. 1.

FIG. 1 illustrates a result of estimating a state of a RTT using GCC with SRTT (smoothed RTT) in a network as an input.

In FIG. 1, the horizontal axis represents a packet number of a received packet. A received packet having the largest packet number is the most recently received packet.

In FIG. 1, the left vertical axis represents an sRTT. Here, the RTT of the received packet received at time t is RTT_t, and the sRTT of the received packet received at time t−1 is set as sRTT_(t-1). Then, sRTT_t, which is the sRTT of the received packet received at the time t, is expressed as the following Mathematical Expression 1.

$$sRTT\_t = \frac{1}{8} \times RTT\_t + \frac{7}{8} \times sRTT\_ ( t - 1 ) \qquad [ Mathematical Expression 1 ]$$

Furthermore, in FIG. 1, the vertical axis on the right side represents an estimation result of the state of the RTT. A state “1” represents that the RTT is increasing, a state “0” represents that the RTT is stable, and a state “−1” represents that the RTT is decreasing.

As illustrated in FIG. 1, the GCC can estimate the state of the RTT at a high speed.

However, even if the RTT is actually stable, the GCC often determines that the state of the RTT is increased or decreased. As a result, it can be seen that the GCC does not stabilize the estimation accuracy of the state of the RTT.

In consideration of the above-described problems, an object of the present disclosure is to provide a network state estimation apparatus, a network state estimation system, and a network state estimation method capable of stabilizing estimation accuracy of a network state.

### Solution to Problem

### A Network State Estimation Method According to an Aspect Includes:

a round trip time (RTT) acquisition step of acquiring an RTT of each of a first received packet and a second received packet received via a network;
a difference calculation step of calculating an RTT difference that is a difference between the RTT of the first received packet and the RTT of the second received packet;
a filtering step of performing smoothing on the RTT difference by using a plurality of stages of Kalman filters connected in series with each other;
a threshold specifying step of specifying a threshold for an output of a final stage of Kalman filter among the plurality of stages of Kalman filters on the basis of an output of a first stage of Kalman filter among the plurality of stages of Kalman filters; and
a state estimation step of comparing the output of the final stage of Kalman filter among the plurality of stages of Kalman filters with the specified threshold and estimating a state of the network on the basis of the comparison result.

### A Network State Estimation Apparatus According to Another Aspect Includes:

a round trip time (RTT) acquisition unit configured to acquire an RTT of each of a first received packet and a second received packet received via a network;
a difference calculation unit configured to calculate an RTT difference that is a difference between the RTT of the first received packet and the RTT of the second received packet;
a filtering unit configured to perform smoothing on the RTT difference by using a plurality of stages of Kalman filters connected in series with each other;
a threshold specifying unit configured to specify a threshold for an output of a final stage of Kalman filter among the plurality of stages of Kalman filters on the basis of an output of a first stage of Kalman filter among the plurality of stages of Kalman filters; and
a state estimation unit configured to compare the output of the final stage of Kalman filter among the plurality of stages of Kalman filters with the specified threshold and to estimate a state of the network on the basis of the comparison result.

### A Network State Estimation System According to Still Another Aspect Includes:

a round trip time (RTT) acquisition unit configured to acquire an RTT of each of a first received packet and a second received packet received via a network;
a difference calculation unit configured to calculate an RTT difference that is a difference between the RTT of the first received packet and the RTT of the second received packet;
a filtering unit configured to perform smoothing on the RTT difference by using a plurality of stages of Kalman filters connected in series with each other;
a threshold specifying unit configured to specify a threshold for an output of a final stage of Kalman filter among the plurality of stages of Kalman filters on the basis of an output of a first stage of Kalman filter among the plurality of stages of Kalman filters; and
a state estimation unit configured to compare the output of the final stage of Kalman filter among the plurality of stages of Kalman filters with the specified threshold and to estimate a state of the network on the basis of the comparison result.

### Advantageous Effects of Invention

According to the aspects described above, it is possible to provide a network state estimation apparatus, a network state estimation system, and a network state estimation method capable of stabilizing estimation accuracy of a network state.

### BRIEF DESCRIPTION OF DRAWINGS

FIG. 1 is a view explaining a problem of GCC.

FIG. 2 is a view illustrating a configuration example of a network state estimation apparatus according to a first example embodiment.

FIG. 3 is a flowchart illustrating an example of a schematic operation flow of the network state estimation apparatus according to the first example embodiment.

FIG. 4 is a view illustrating a configuration example of a network state estimation system according to the first example embodiment.

FIG. 5 is a view illustrating a configuration example of a network state estimation apparatus according to a second example embodiment.

FIG. 6 is a view illustrating an example of an sRTT output from an sRTT acquisition unit according to the second example embodiment.

FIG. 7 is a view illustrating an example of an RTT difference output from a difference calculation unit according to the second example embodiment.

FIG. 8 is a view illustrating an example of an RTT difference that is output from a first stage of Kalman filter and is subjected to one stage of smoothing according to the second example embodiment.

FIG. 9 is a view illustrating an example of an RTT difference that is output from a final stage of Kalman filter and is subjected to two stages of smoothing according to the second example embodiment.

FIG. 10 is a view illustrating an example of a threshold output from a threshold specifying unit according to the second example embodiment.

FIG. 11 is a view illustrating an example of an RTT state estimation result output from a state estimation unit according to the second example embodiment.

FIG. 12 is a view illustrating an example of a result of estimating a state of an RTT in a certain mobile network by GCC.

FIG. 13 is a view illustrating an example of a result of estimating a state of an RTT in the same mobile network as in FIG. 12 by the state estimation unit according to the second example embodiment.

FIG. 14 is a flowchart illustrating an example of a schematic operation flow of the network state estimation apparatus according to the second example embodiment.

FIG. 15 is a view illustrating a configuration example of a network state estimation apparatus according to a third example embodiment.

FIG. 16 is a view illustrating an example of a method of calculating a reception interval by a reception interval calculation unit according to the third example embodiment.

FIG. 17 is a flowchart illustrating an example of a schematic operation flow of the reception interval calculation unit according to the third example embodiment.

FIG. 18 is a block diagram illustrating a hardware configuration example of a computer that realizes the network state estimation apparatus according to the first, second, and third example embodiments.

### EXAMPLE EMBODIMENT

Example embodiments of the present disclosure will be described below with reference to the drawings. Note that, in the description and drawings to be described below, omission and simplification are made as appropriate for clarity of description. Furthermore, in each of the drawings described below, the same element is denoted by the same reference numeral, and redundant description will be omitted as necessary. In addition, specific numerical values and the like shown below are only examples to facilitate understanding of the present disclosure, and are not limited thereto.

### First Example Embodiment

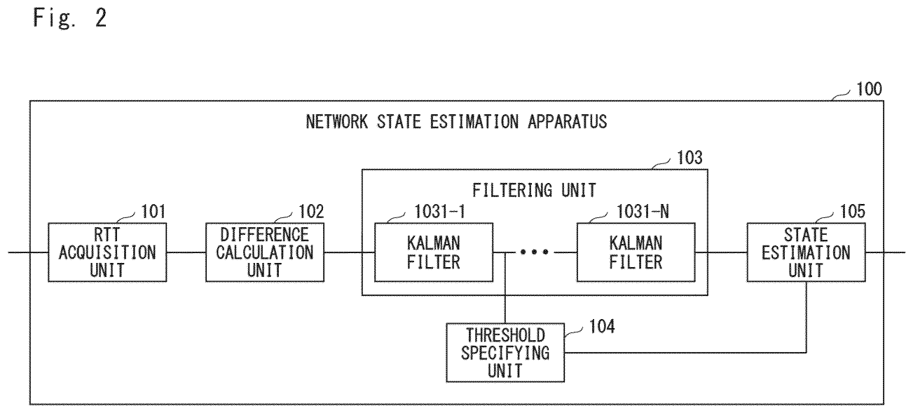

First, a configuration example of a network state estimation apparatus 100 according to a first example embodiment will be described with reference to FIG. 2.

As illustrated in FIG. 2, a network state estimation apparatus 100 according to the first example embodiment includes an RTT acquisition unit 101, a difference calculation unit 102, a filtering unit 103, a threshold specifying unit 104, and a state estimation unit 105.

The network state estimation apparatus 100 may be an apparatus that transmits and receives packets. In this case, the network state estimation apparatus 100 estimates a state of a network used by the network state estimation apparatus 100 for transmission and reception of packets. The network state estimation apparatus 100 may be an apparatus that is provided separately from another apparatus that transmits and receives packets. In this case, the network state estimation apparatus 100 estimates a state of a network used by another apparatus for transmission and reception of packets.

The RTT acquisition unit 101 acquires an RTT of each of a first received packet and a second received packet received via the network. Note that, it is assumed that the first received packet and the second received packet are received in this order. For example, the RTT of the first received packet is a time from when the network state estimation apparatus 100 or another apparatus transmits a transmission packet until the first received packet that is a response packet to the transmission packet is received by the network state estimation apparatus 100 or the other apparatus. Note that, the RTT may be calculated by any constituent element in the network state estimation apparatus 100 or may be received from an external apparatus.

The difference calculation unit 102 calculates an RTT difference that is a difference (that is, a gradient) between the RTT of the first received packet and the RTT of the second received packet.

The filtering unit 103 includes a plurality of stages of Kalman filters 1031-1 to 1031-N (N is an integer of 2 or more) connected in series with each other. The filtering unit 103 smooths the RTT difference calculated by the difference calculation unit 102 using the plurality of stages of Kalman filters 1031-1 to 1031-N.

The threshold specifying unit 104 specifies a threshold with respect to an output of the final stage of Kalman filter 1031-N among the plurality of stages of Kalman filters 1031-1 to 1031-N on the basis of an output of the first stage of Kalman filter 1031-1 among the plurality of stages of Kalman filters 1031-1 to 1031-N, that is, the result of one stage of smoothing performed on the RTT difference described above.

The state estimation unit 105 compares the output of the final stage of Kalman filter 1031-N among the plurality of stages of Kalman filters 1031-1 to 1031-N, that is, a result of N stages of smoothing performed on the above-described RTT difference with a threshold specified by the threshold specifying unit 104, and estimates a state of the network on the basis of the comparison result. The state of the network represents a communication situation in the network, and represents, for example, an increase or decrease situation of RTT in the network.

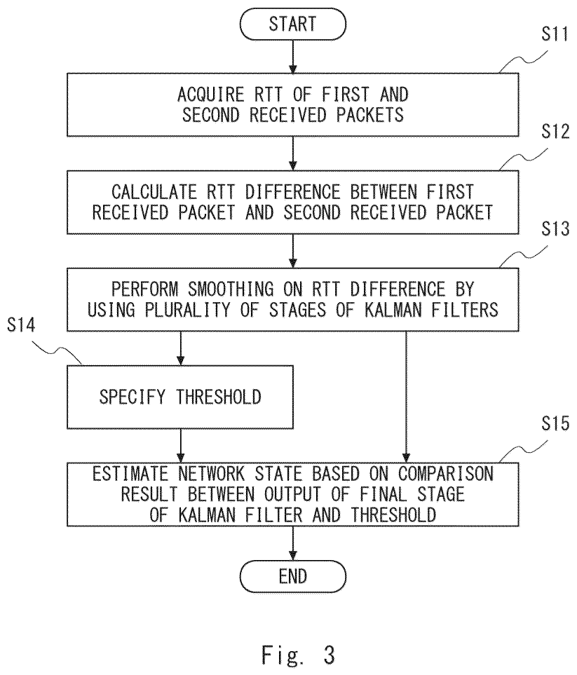

Next, an example of a schematic operation flow of the network state estimation apparatus 100 according to the present first example embodiment will be described with reference to FIG. 3.

As illustrated in FIG. 3, first, the RTT acquisition unit 101 acquires the RTT of each of the first received packet and the second received packet received via the network (step S11).

Next, the difference calculation unit 102 calculates an RTT difference that is a difference between the RTT of the first received packet and the RTT of the second received packet (step S12).

Next, the filtering unit 103 smooths the RTT difference calculated by the difference calculation unit 102 by using the plurality of stages of Kalman filters 1031-1 to 1031-N (step S13).

Next, the threshold specifying unit 104 specifies the threshold on the basis of the output of the first stage of Kalman filter 1031-1 among the plurality of stages of Kalman filters 1031-1 to 1031-N (step S14). Note that, step S14 may be performed at a point of time when smoothing by the first stage of Kalman filter 1031-1 is completed in the middle of step S13 without waiting for completion of step S13.

Then, the state estimation unit 105 compares the output of the final stage of Kalman filter 1031-N among the plurality of stages of Kalman filters 1031-1 to 1031-N with a threshold specified by the threshold specifying unit 104, and estimates a state of the network on the basis of the comparison result (step S15).

As described above, according to the first example embodiment, the network state estimation apparatus 100 acquires the RTT of each of the first received packet and the second received packet received via the network, and calculates the RTT difference that is a difference between the RTT of the first received packet and the RTT of the second received packet. Then, the network state estimation apparatus 100 smooths the RTT difference by using the plurality of stages of Kalman filters 1031-1 to 1031-N. Then, the network state estimation apparatus 100 specifies a threshold on the basis of the output of the first stage of Kalman filter 1031-1, compares the output of the final stage of Kalman filter 1031-N with the threshold, and estimates the state of the network on the basis of the comparison result. In this manner, when smoothing the RTT difference by using the plurality of stages of Kalman filters 1031-1 to 1031-N, it is possible to stabilize the estimation accuracy of the state of the network. In addition, as a result, it is possible to appropriately perform remote monitoring or remote control by using a stabilized estimation result of the state of the network.

Note that, the RTT acquisition unit 101 may further acquire an sRTT from the RTT of each of the first received packet and the second received packet by using the above-described Mathematical Expression 1. In this case, the constituent elements at the subsequent stage of the RTT acquisition unit 101 may estimate the state of the network by using the sRTT of each of the first received packet and the second received packet.

In addition, the threshold specifying unit 104 may calculate a candidate threshold that is a candidate for the threshold at the time of receiving the second received packet on the basis of the threshold at the time of receiving the first received packet and the output of the first stage of Kalman filter 1031-1 which is obtained by smoothing the RTT difference, calculate a maximum value between the calculated candidate threshold and a predetermined lower limit value, and specify the calculated maximum value as the threshold at the time of receiving the second received packet.

Furthermore, the lower limit value may be set on the basis of scheduling characteristics of the network. The schedule characteristics of the network are, for example, an interval of uplink slots allocated to an uplink in a case where there is an apparatus that performs communication by time division duplex (TDD) in the network. For example, it is assumed that a transmission source of a received packet received by the network state estimation apparatus 100 or another apparatus is a base station that performs communicating in the TDD scheme. In this case, the interval of the uplink slots is generally longer than an interval between downlink slots allocated to a downlink. Therefore, even when a packet to be transmitted to the base station is generated, a terminal such as a user equipment (UE) connected to the base station cannot immediately transmit the packet and may be kept waiting until the next uplink slot. Therefore, the RTT varies at a constant cycle depending on the interval of the uplink slots. Therefore, in a case where the transmission source of the received packet is the above-described base station, the lower limit value is set on the basis of the interval of the uplink slots so as not to fall below the variation of the RTT.

Further, the state estimation unit 105 may estimate an increase or decrease state of the RTT in the network as the state of the network.

In addition, the network state estimation apparatus 100 may further include a reception interval calculation unit that calculates a reception interval between the first received packet and the second received packet on the basis of the transmission interval of the transmission packet for the first received packet and the second received packet, the RTT of the first received packet, and the RTT of the second received packet.

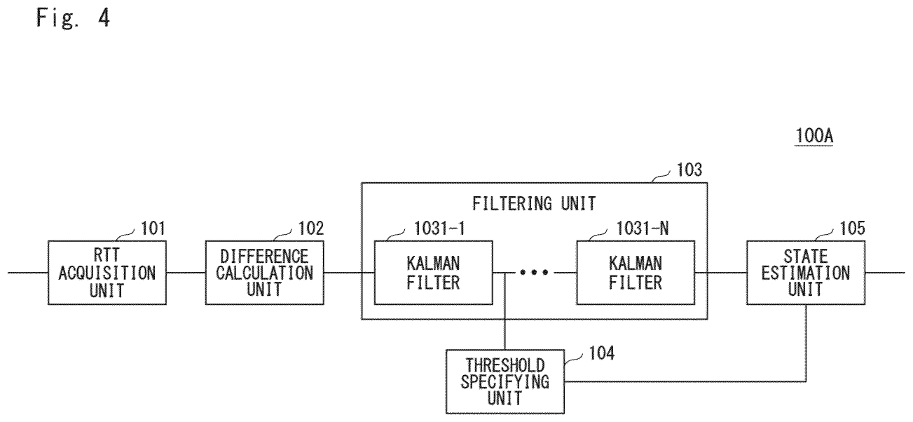

In addition, the RTT acquisition unit 101, the difference calculation unit 102, the filtering unit 103, the threshold specifying unit 104, and the state estimation unit 105 are not limited to being provided in one apparatus (network state estimation apparatus 100). As illustrated in FIG. 4, the RTT acquisition unit 101, the difference calculation unit 102, the filtering unit 103, the threshold specifying unit 104, and the state estimation unit 105 may be provided in a distributed manner in different apparatuses, clouds, or the like to constitute a network state estimation system 100A.

### Second Example Embodiment

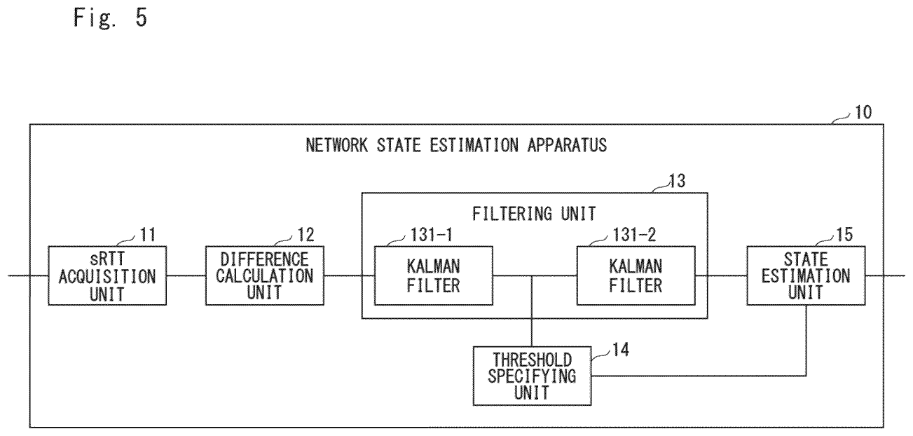

Next, a configuration example of a network state estimation apparatus 10 according to a second example embodiment will be described with reference to FIG. 5. The second example embodiment corresponds to an example embodiment in which the above-described first example embodiment is further embodied.

As illustrated in FIG. 5, a network state estimation apparatus 10 according to the second example embodiment includes an sRTT acquisition unit 11, a difference calculation unit 12, a filtering unit 13, a threshold specifying unit 14, and a state estimation unit 15.

The network state estimation apparatus 10 may be an apparatus that transmits and receives packets. In this case, the network state estimation apparatus 10 estimates a state of a network used by the network state estimation apparatus 10 for transmission and reception of packets. The network state estimation apparatus 10 may be an apparatus that is provided separately from another apparatus that transmits and receives packets. In this case, the network state estimation apparatus 10 estimates a state of a network used by another apparatus for transmission and reception of packets.

The sRTT acquisition unit 11 acquires an sRTT of each received packet received via the network. Note that, the sRTT may be calculated by any constituent element in the network state estimation apparatus 10 or may be received from an external apparatus. For example, when the sRTT acquisition unit 11 calculates the sRTT, first, the sRTT acquisition unit 11 may acquire the RTT of each received packet by using ping, and may further calculate and acquire the sRTT of each received packet from the RTT of each received packet by using Mathematical Expression 1 described above. However, the method for obtaining the sRTT is not limited thereto. Note that, the RTT of the received packet is a time from when the network state estimation apparatus 10 or another apparatus transmits a transmission packet until the received packet that is a response packet to the transmission packet is received by the network state estimation apparatus or the other apparatus.

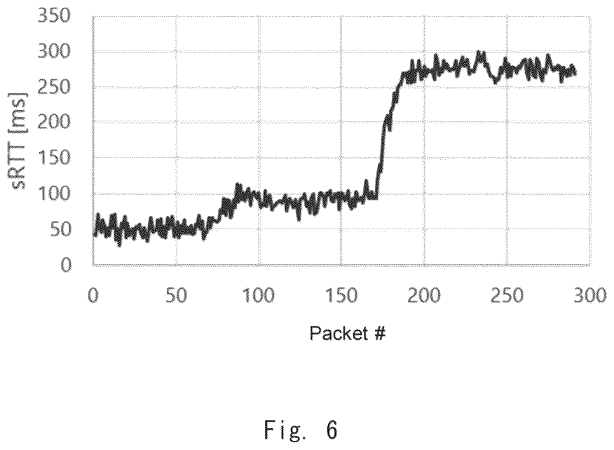

FIG. 6 illustrates an example of the sRTT output from the sRTT acquisition unit 11. In FIG. 6, the horizontal axis represents a packet number of the received packet, and the vertical axis represents sRTT.

For each received packet, the difference calculation unit 12 calculates an RTT difference that is a difference (that is, a gradient) between the sRTT of the received packet and an sRTT of a received packet received before the received packet.

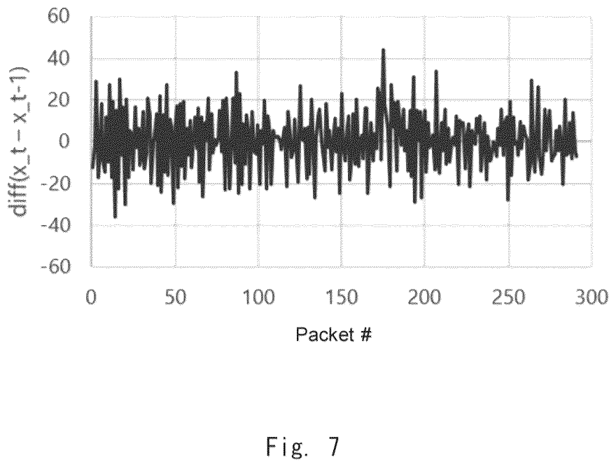

FIG. 7 illustrates an example of the RTT difference output from the difference calculation unit 12. In FIG. 7, the horizontal axis represents a packet number of the received packet, and the vertical axis represents an RTT difference. In addition, in the vertical axis, x_t represents the sRTT of the received packet received at time t, and x_t-1 represents the sRTT of the received packet received at time t−1.

The filtering unit 13 includes two stages of Kalman filters 131-1 and 131-2 connected in series with each other. However, the number of stages of the Kalman filter included in the filtering unit 13 is not limited to two stages, and may be three stages or more. The filtering unit 13 smooths the RTT difference calculated by the difference calculation unit 12 by using the two stages of Kalman filters 131-1 and 131-2.

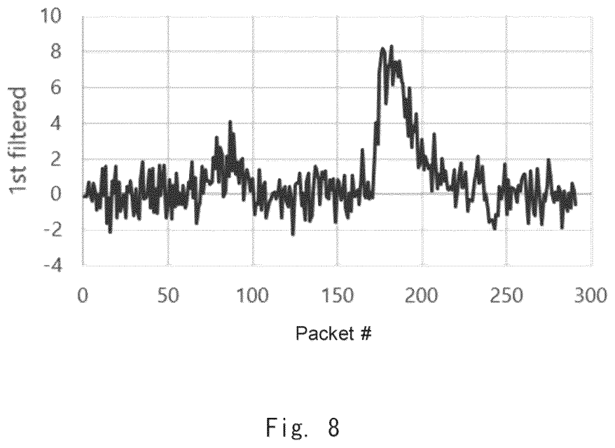

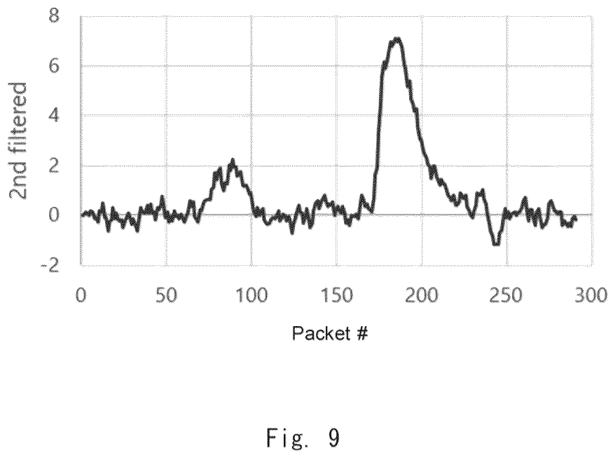

FIG. 8 illustrates an example of the RTT difference that is output from the first stage of Kalman filter 131-1 and is subjected to one stage of smoothing. In addition, FIG. 9 illustrates an example of the RTT difference that is output from the final stage of Kalman filter 131-2 and is subjected to two stages of smoothing. In FIGS. 8 and 9, the horizontal axis represents a packet number of the received packet, and the vertical axis represents the RTT difference subjected to smoothing.

The threshold specifying unit 14 specifies a threshold on the basis of the output of the first stage of Kalman filter 131-1 among the two stages of Kalman filters 131-1 and 131-2, that is, the RTT difference subjected to the one stage of smoothing.

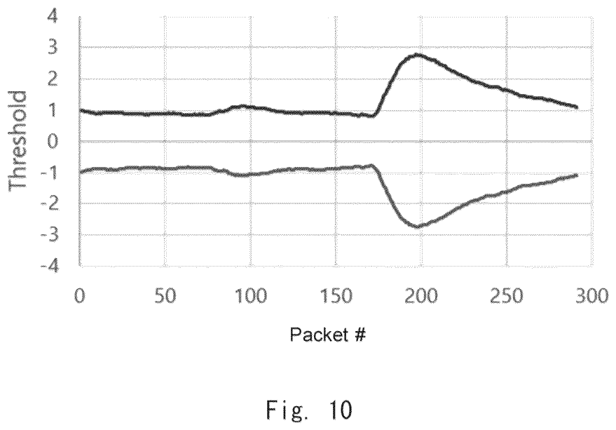

FIG. 10 illustrates an example of the threshold output from the threshold specifying unit 14. In FIG. 10, the horizontal axis represents a packet number of the received packet, and the vertical axis represents a threshold. As illustrated in FIG. 10, the threshold is dynamically set for each received packet at the time of receiving the received packet. In addition, the threshold is set on each of a positive side and a negative side, and the threshold on the positive side and the threshold on the negative side are symmetrical values with an axial line of the threshold “0” interposed therebetween.

The state estimation unit 15 compares the output of the final stage of Kalman filter 131-2 among the two stages of Kalman filters 131-1 and 131-2, that is, the RTT difference subjected to the two stages of smoothing, with the threshold specified by the threshold specifying unit 14. Then, on the basis of the comparison result, the state estimation unit 15 estimates the state (increase or decrease state) of the RTT in the network as the state of the network. Here, it is assumed that the state estimation unit 15 estimates whether the state of the RTT is increased, stabilized, or decreased. For example, in a case where the threshold on the positive side and the threshold on the negative side are specified by the threshold specifying unit 14, the state estimation unit 15 estimates that the RTT is increased when the output of the final stage of Kalman filter 131-2 is larger than the threshold on the positive side, estimates that the RTT is decreased when the output of the final stage of Kalman filter 131-2 is smaller than the threshold on the negative side, and estimates that the RTT is stable when the output of the final stage of Kalman filter 131-2 is within a range between the threshold on the positive side and the threshold on the negative side.

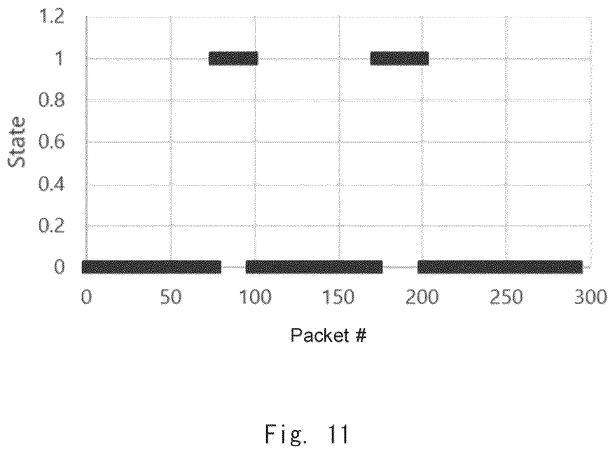

FIG. 11 illustrates an example of the RTT state estimation result output from the state estimation unit 15. In FIG. 11, the horizontal axis represents a packet number of the received packet, and the vertical axis represents an estimation result of the state of the RTT. State “1” represents that the RTT increases, and State “0” represents that the RTT is stable. In addition, although not illustrated, it is assumed that State “−1” represents that the RTT decreases.

Hereinafter, a method of specifying the threshold by the threshold specifying unit 14 will be described in detail. Here, for comparison, first, a method of specifying a threshold by GCC described in Non-Patent Literature 1 will be described.

In the GCC, a threshold at the time of receiving an i^{th} received packet is set as γ(tᵢ), a threshold at the time of receiving an (i−1)^{th} received packet is set as γ(tᵢ₋₁), and an output of the first stage of Kalman filter for the i^{th} received packet is set as m(tᵢ). Note that, in the GCC, since only one stage of Kalman filter is provided, the output of the one stage of Kalman filter is the output of the first stage of the Kalman filter. In the GCC, γ(tᵢ) is specified as in the following Mathematical Expression 2.

$$γ ( {t}_{i} ) = γ ( {t}_{i - 1} ) + Δ T \times {k}_{γ} ( {t}_{i} ) ( \vert m ( {t}_{i} ) \vert - γ ( {t}_{i - 1} ) ) \qquad [ Mathematical Expression 2 ]$$

Here, ΔT=tᵢ−tᵢ₋₁, and k_{γ}(tᵢ) is a coefficient at the time of receiving the i^{th} received packet and is a coefficient that varies depending on time.

Next, a method of specifying a threshold by the threshold specifying unit 14 according to the second example embodiment will be described.

The threshold specifying unit 14 sets a lower limit value according to the schedule characteristics of the network and specifies the threshold so as not to fall below the lower limit value. The schedule characteristics of the network are, for example, an interval of uplink slots in a case where there is an apparatus that performs communication by TDD in the network.

For example, it is assumed that a transmission source of a received packet received by the network state estimation apparatus 10 or another apparatus is a base station that performs communicating in the TDD scheme. In this case, as described above, the RTT varies at a constant cycle depending on the interval of the uplink slots.

Therefore, in a case where the transmission source of the received packet is the above-described base station, the threshold specifying unit 14 sets a lower limit value on the basis of an interval of the uplink slots so as not to fall below the variation of the RTT. Specifically, when the interval of the uplink slots is T_{tdd}, the threshold specifying unit 14 sets the lower limit value γ_{tdd}(tᵢ) to T_{tdd}.

Then, the threshold specifying unit 14 specifies γ(tᵢ) as in the following Mathematical Expression 3.

$$γ ( {t}_{i} ) = max \{ γ ( {t}_{i - 1} ) + {k}_{γ} ( \vert m ( {t}_{i} ) \vert - γ ( {t}_{i - 1} ) ) , {γ}_{tdd} ( {t}_{i} ) \} \qquad [ Mathematical Expression 3 ]$$

Here, γ(tᵢ), γ(tᵢ₋₁), and m(tᵢ) are the same as in Mathematical Expression 2. Note that, in the second example embodiment, since the two stage of Kalman filters 131-1 and 131-2 are provided, the output of the Kalman filter 131-1 is the output of the first stage of Kalman filter, that is, m(tᵢ). In addition, k_{γ} is a fixed coefficient having no time variation. In the second example embodiment, when using k_{γ} that is a fixed coefficient, the calculation cost and the calculation time can be reduced as compared with the GCC using ΔT×k_{γ}(tᵢ) that varies depending on time.

As shown in Mathematical Expression 3, first, the threshold specifying unit 14 calculates a candidate threshold that is a candidate for the threshold by a similar method as in Mathematical Expression 2 except that k_{γ} is used, and calculates a maximum value between the calculated candidate threshold and the above-described lower limit value. Then, the threshold specifying unit 14 specifies the calculated maximum value as γ(tᵢ).

Next, an example of a result of estimating the state of the RTT by the state estimation unit 15 according to the second example embodiment will be described. Here, an example of a result of estimating the state of the RTT by GCC described in Non-Patent Literature 1 will also be described for comparison.

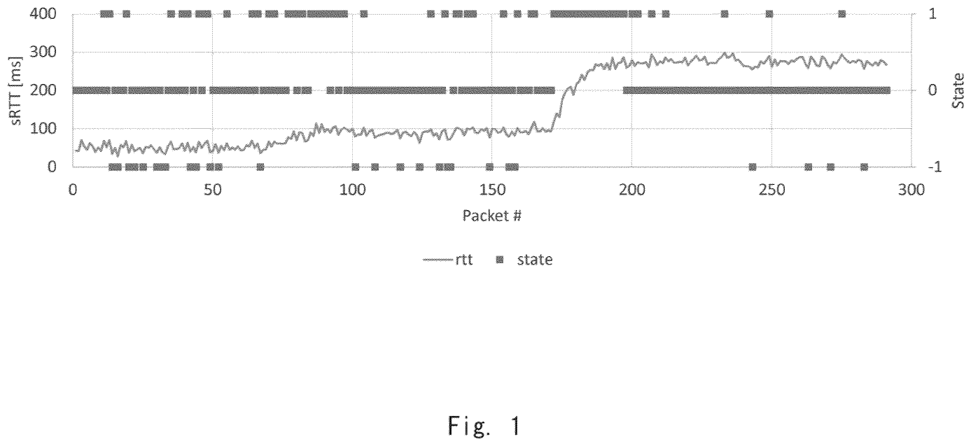

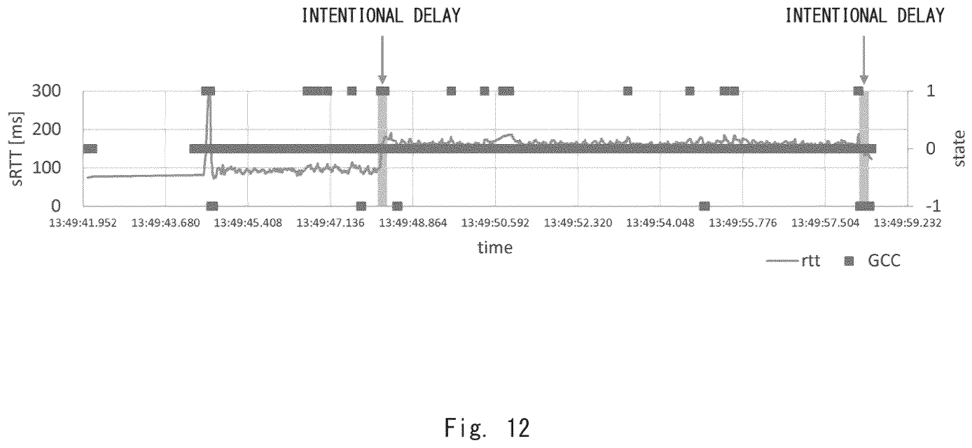

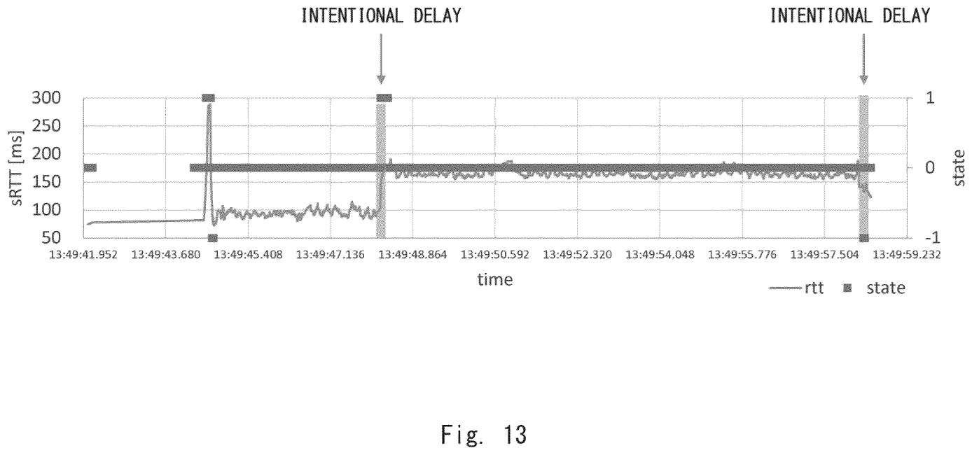

FIG. 12 illustrates an example of a result of estimating a state of an RTT in a certain mobile network by GCC. In the mobile network in FIG. 12, an intentional delay is generated in the middle of communication. FIG. 13 illustrates an example of a result of estimating a state of an RTT in the same mobile network as in FIG. 12 by the state estimation unit 15 according to the second example embodiment. In FIG. 12 and FIG. 13, the horizontal axis represents a reception time of a received packet, and the left vertical axis and the right vertical axis are similar to those in FIG. 1.

As illustrated in FIGS. 12 and 13, in the second example embodiment, it can be seen that the state (increase, decrease, or stability) of the RTT is accurately estimated even at the time when the delay is intentionally changed while being more robust to the fluctuation of the sRTT than the GCC.

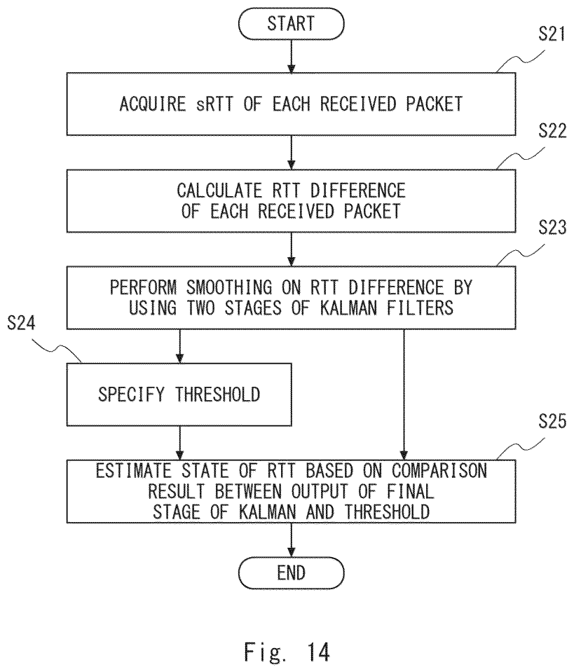

Next, an example of a schematic operation flow of the network state estimation apparatus 10 according to the present second example embodiment will be described with reference to FIG. 14.

As illustrated in FIG. 14, first, the sRTT acquisition unit 11 acquires an sRTT of each received packet received via the network (step S21).

Next, for each received packet, the difference calculation unit 12 calculates an RTT difference that is a difference between the sRTT of the received packet and an sRTT of a received packet received before the received packet (step S22).

Next, the filtering unit 13 smooths the RTT difference calculated by the difference calculation unit 12 by using two stages of Kalman filters 131-1 and 131-2 (step S23).

Next, the threshold specifying unit 14 specifies the threshold on the basis of the output of the first stage of Kalman filter 131-1 among the two stages of Kalman filters 131-1 and 131-2 (step S24). Note that, step S24 may be performed at a point of time when smoothing by the first stage of Kalman filter 131-1 is completed in the middle of step S23 without waiting for completion of step S23.

Then, the state estimation unit 15 compares the output of the final stage of Kalman filter 131-2 among the two stages of Kalman filters 131-1 and 131-2 with a threshold specified by the threshold specifying unit 14, and estimates a state of the RTT in the network on the basis of the comparison result (step S25).

As described above, according to the second example embodiment, the network state estimation apparatus 10 acquires the sRTT of each received packet received via the network and calculates the RTT difference for each received packet. Then, the network state estimation apparatus 10 smooths the RTT difference by using the two stages of Kalman filters 131-1 and 131-2. Then, the network state estimation apparatus 10 specifies a threshold on the basis of the output of the first stage of Kalman filter 131-1, compares the output of the final stage of Kalman filter 131-2 with the threshold, and estimates the state of the RTT in the network on the basis of the comparison result. In this manner, when smoothing the RTT difference by using the two stages of Kalman filters 131-1 and 131-2, it is possible to stabilize the estimation accuracy of the state of the RTT in the network. In addition, as a result, it is possible to appropriately perform remote monitoring or remote control by using a stabilized estimation result of the state of the RTT in the network.

According to the second example embodiment, the network state estimation apparatus 10 sets the lower limit value of the threshold on the basis of the schedule characteristic of the network, and specifies the maximum value of the candidate threshold and the lower limit value as the threshold. As a result, the threshold can be specified so as not to fall below the lower limit value. Such specifying of the threshold can also contribute to stabilization of the estimation accuracy of the state of the RTT.

### Third Example Embodiment

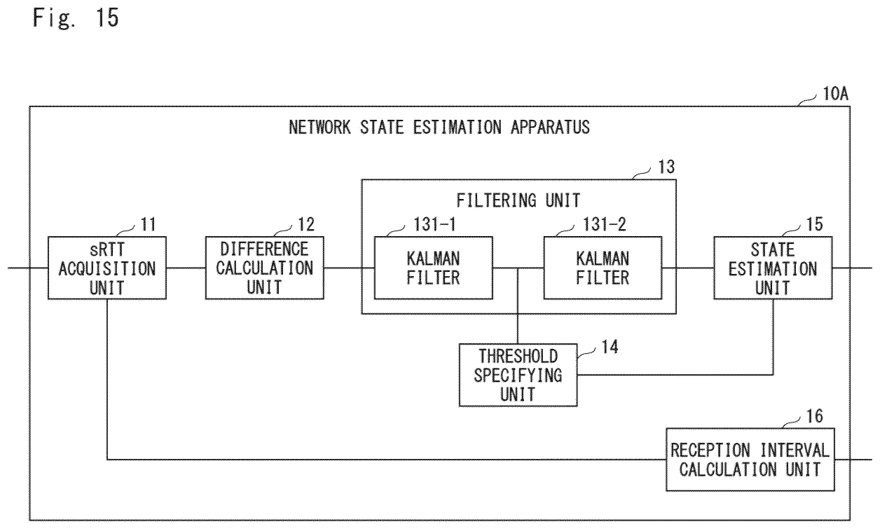

Next, a configuration example of a network state estimation apparatus 10A according to a third example embodiment will be described with reference to FIG. 15.

As illustrated in FIG. 15, the network state estimation apparatus 10A according to the present third example embodiment is different from the network state estimation apparatus 10 according to the above-described second example embodiment in that a reception interval calculation unit 16 is added.

The reception interval calculation unit 16 calculates a reception interval of received packets.

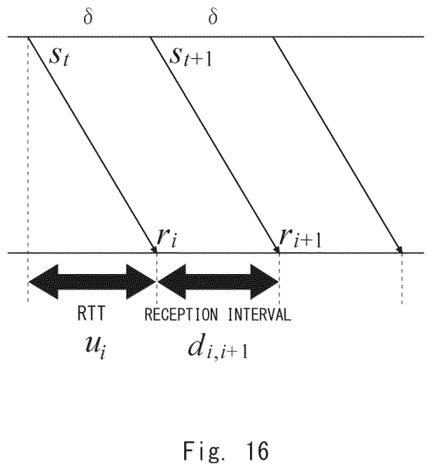

Hereinafter, a method of calculating the reception interval by the reception interval calculation unit 16 will be described in detail with reference to FIG. 16.

A transmission interval of a transmission packet transmitted by the network state estimation apparatus 10 or another apparatus is set as δ, a transmission time at which an i^{th} transmission packet is transmitted is set as sᵢ, and a reception time at which an i^{th} received packet that is a response packet to the i^{th} transmission packet is received by the network state estimation apparatus 10 or another apparatus is set as rᵢ.

At this time, uᵢ that is an RTT of the i^{th} received packet is calculated as in the following Mathematical Expression 4.

$${u}_{i} = {r}_{i} - {s}_{i} \qquad [ Mathematical Expression 4 ]$$

Further, a reception interval d_{i,i+1} between the i^{th} received packet and an (i+1)^{th} received packet is calculated as in the following Mathematical Expression 5.

$${d}_{i , i + 1} = {r}_{i + 1} - {r}_{i} \qquad [ Mathematical Expression 5 ]$$

Here, when Mathematical Expression 5 of the reception interval is transformed using Mathematical Expression 4 of the RTT, the following Mathematical Expression 6 is obtained.

$$\begin{matrix}{d}_{i , i + 1} = {r}_{i + 1} - {r}_{i} \\ = ( {u}_{i + 1} - {u}_{i} ) + ( {s}_{i + 1} - {s}_{i} ) \\ = ( {u}_{i + 1} - {u}_{i} ) + δ\end{matrix} \qquad [ Mathematical Expression 6 ]$$

As described above, the reception interval d_{i,i+1} can be calculated based on the transmission interval 8 of the transmission packet, uᵢ that is the RTT of the i^{th} received packet, and uᵢ₊₁ that is the RTT of the (i+1)^{th} received packet.

Therefore, the reception interval calculation unit 16 calculates the reception interval between the i^{th} received packet and the (i+1)^{th} received packet on the basis of the transmission interval of the transmission packet, the RTT of the i^{th} received packet, and the RTT of the (i+1)^{th} received packet.

Among these, the transmission interval of the transmission packet is a predetermined setting value. Therefore, the reception interval calculation unit 16 retains the transmission interval of the transmission packet in advance.

Further, the reception interval calculation unit 16 acquires the RTT of the i^{th} and (i+1)^{th} received packet from the sRTT acquisition unit 11. However, the present invention is not limited thereto, and the reception interval calculation unit 16 may acquire the RTT of the i^{th} and (i+1)^{th} received packets by using ping by itself.

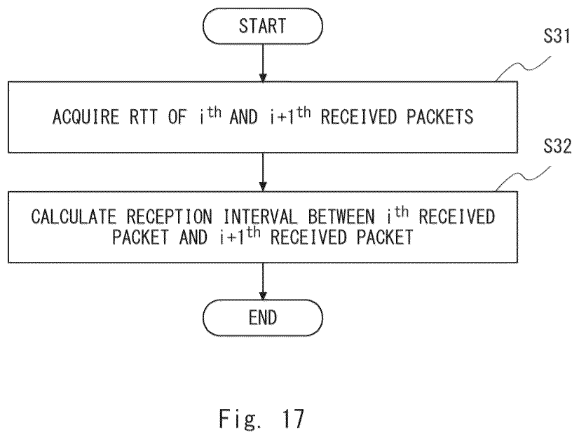

Next, an example of a schematic operation flow of the reception interval calculation unit 16 according to the third example embodiment will be described with reference to FIG. 17. Here, the reception interval calculation unit 16 calculates a reception interval between the i^{th} received packet and the (i+1)th received packet.

As illustrated in FIG. 17, first, the reception interval calculation unit 16 acquires the RTT of the i^{th} and (i+1)^{th} received packets from the sRTT acquisition unit 11 (step S31).

Thereafter, the reception interval calculation unit 16 calculates the reception interval between the i^{th} received packet and the (i+1)^{th} received packet on the basis of the transmission interval of the transmission packet retained in advance and the RTT of the i^{th} and (i+1)^{th} received packets (step S31).

Note that, the network state estimation apparatus 10A executes the operation illustrated in FIG. 14 similar to the second example embodiment described above in addition to the operation illustrated in FIG. 17. The network state estimation apparatus 10A may sequentially execute the operations in any order, or may execute the operations substantially simultaneously and in parallel.

As described above, according to the third example embodiment, the network state estimation apparatus 10A calculates the reception interval between the i^{th} received packet and the (i+1)^{th} received packet on the basis of the transmission interval of the transmission packet and the RTT of the i^{th} and (i+1)th received packets. As a result, the reception interval of the received packets can be calculated. Therefore, remote monitoring or remote control can be performed in consideration of not only the state of the RTT in the network but also the reception interval of the received packets. Further, on the application side, in general, a setting value of the base station such as an uplink slot interval T_{tdd} cannot be obtained from the base station. Therefore, the lower limit value γ_{tdd} of the dynamic threshold is optimized by estimating T_{tdd} by using the reception interval of the received packets, and it is expected that the state of the network (state of RTT) can be estimated with high accuracy.

The other effects are similar to effects according to the second example embodiment described above.

### <Hardware Configuration of Network State Estimation Apparatus According to Example Embodiments>

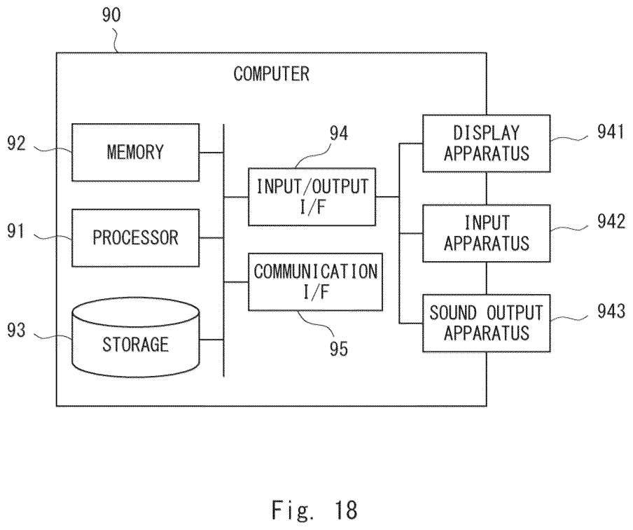

Next, a hardware configuration example of a computer 90 that implements the network state estimation apparatuses 100, 10, and 10A according to the above-described first, second, and third example embodiments will be described with reference to FIG. 18.

As illustrated in FIG. 18, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission line for mutually transmitting or receiving data.

The processor 91 is, for example, an arithmetic processing apparatus such as a central processing unit (CPU) and a graphics processing unit (GPU). The memory 92 is, for example, a memory such as a random access memory (RAM) and a read only memory (ROM). The storage 93 is, for example, a storage device such as a hard disk drive (HDD), a solid state drive (SSD), and a memory card. Furthermore, the storage 93 may be a memory such as a RAM and a ROM.

The storage 93 stores programs for realizing functions of constituent elements included in the network state estimation apparatuses 100, 10, and 10A. The processor 91 implements the functions of the constituent elements included in the network state estimation apparatuses 100, 10, and 10A by executing the programs. Here, in execution of each of the programs described above, the processor 91 may load the programs into the memory 92, and may execute the programs, or may execute the programs without loading the programs into the memory 92. The memory 92 and the storage 93 also serve to implement storage functions of the network state estimation apparatuses 100, 10, and 10A.

Furthermore, the above-described program includes a command group (or software code) for causing a computer to perform one or more functions in the network state estimation apparatus 100, 10, or 10A described in the above-described example embodiments when being read by the computer. The program may be stored in a non-transitory computer-readable medium or a tangible storage medium. As an example and not by way of limitation, the computer readable medium or the tangible storage medium includes a RAM, a ROM, a flash memory, an SSD or other memory technologies, a compact disc (CD)-ROM, a digital versatile disc (DVD), a Blu-ray (registered trademark) disk or other optical disk storages, a magnetic cassette, a magnetic tape, a magnetic disk storage, or other magnetic storage apparatuses. The program may be transmitted on a transitory computer readable medium or a communication medium. As an example and not by way of limitation, the transitory computer readable medium or the communication medium includes an electrical signal, an optical signal, an acoustic signal, or other forms of propagation signals.

The input/output interface 94 is connected to a display apparatus 941, an input apparatus 942, a sound output apparatus 943, and the like. The display apparatus 941 is an apparatus that displays a screen that corresponds to drawing data that has been processed by the processor 91 such as a liquid crystal display (LCD), a cathode ray tube (CRT) display, and monitor. The input apparatus 942 is an apparatus that receives an operation input of an operator, and is, for example, a keyboard, a mouse, a touch sensor, or the like. The display apparatus 941 and the input apparatus 942 may be integrated, and may be implemented as a touch panel. The sound output apparatus 943 is an apparatus that acoustically outputs sound that corresponds to acoustic data that has been processed by the processor 91 such as a speaker.

The communication interface 95 transmits or receives data to and from an external apparatus. For example, the communication interface 95 performs communication with an external apparatus via the wired communication line or the wireless communication line.

The present disclosure has been described above with reference to the example embodiments, but the present disclosure is not limited to the example embodiments described above. Various modifications that can be understood by those skilled in the art can be made to the configuration and details of the present disclosure within the scope of the present disclosure.

For example, the above-described example embodiments may be used in combination.

In addition, some or all of the above-described example embodiments may be described in supplementary notes below, but are not limited thereto.

### (Supplementary Note 1)

A network state estimation method, including:
a round trip time (RTT) acquisition step of acquiring an RTT of each of a first received packet and a second received packet received via a network;
a difference calculation step of calculating an RTT difference that is a difference between the RTT of the first received packet and the RTT of the second received packet;
a filtering step of performing smoothing on the RTT difference by using a plurality of stages of Kalman filters connected in series with each other;
a threshold specifying step of specifying a threshold for an output of a final stage of Kalman filter among the plurality of stages of Kalman filters on the basis of an output of a first stage of Kalman filter among the plurality of stages of Kalman filters; and
a state estimation step of comparing the output of the final stage of Kalman filter among the plurality of stages of Kalman filters with the specified threshold and estimating a state of the network on the basis of the comparison result.

### (Supplementary Note 2)

The network state estimation method according to Supplementary Note 1,
wherein in the threshold specifying step,
a candidate threshold that is a candidate for the threshold at the time of receiving the second received packet is calculated on the basis of the threshold at the time of receiving the first received packet, and an output of the first stage of Kalman filter that has performed smoothing on the RTT difference,
a maximum value between the calculated candidate threshold and a predetermined lower limit value is calculated, and
the calculated maximum value is specified as the threshold at the time of receiving the second received packet.

### (Supplementary Note 3)

The network state estimation method according to Supplementary Note 2, wherein the lower limit value is set on the basis of a scheduling characteristic of the network.

### (Supplementary Note 4)

The network state estimation method according to any one of Supplementary Notes 1 to 3, wherein in the state estimation step, a state of increase or decrease of the RTT in the network is estimated as a state of the network.

### (Supplementary Note 5)

The network state estimation method according to any one of Supplementary Notes 1 to 4, further including a reception interval calculation step of calculating a reception interval between the first received packet and the second received packet on the basis of a transmission interval of a transmission packet for the first received packet and the second received packet, an RTT of the first received packet, and an RTT of the second received packet.

### (Supplementary Note 6)

A network state estimation apparatus including:
a round trip time (RTT) acquisition unit configured to acquire an RTT of each of a first received packet and a second received packet received via a network;
a difference calculation unit configured to calculate an RTT difference that is a difference between the RTT of the first received packet and the RTT of the second received packet;
a filtering unit configured to perform smoothing on the RTT difference by using a plurality of stages of Kalman filters connected in series with each other;
a threshold specifying unit configured to specify a threshold for an output of a final stage of Kalman filter among the plurality of stages of Kalman filters on the basis of an output of a first stage of Kalman filter among the plurality of stages of Kalman filters; and
a state estimation unit configured to compare the output of the final stage of Kalman filter among the plurality of stages of Kalman filters with the specified threshold and to estimate a state of the network on the basis of the comparison result.

### (Supplementary Note 7)

The network state estimation apparatus according to Supplementary Note 6,
wherein the threshold specifying unit,
calculates a candidate threshold that is a candidate for the threshold at the time of receiving the second received packet on the basis of the threshold at the time of receiving the first received packet, and an output of the first stage of Kalman filter that has performed smoothing on the RTT difference,
calculates a maximum value between the calculated candidate threshold and a predetermined lower limit value, and
specifies the calculated maximum value as the threshold at the time of receiving the second received packet.

### (Supplementary Note 8)

The network state estimation apparatus according to Supplementary Note 7, wherein the lower limit value is set on the basis of a scheduling characteristic of the network.

### (Supplementary Note 9)

The network state estimation apparatus according to any one of Supplementary Notes 6 to 8, wherein the state estimation unit estimates a state of increase or decrease of the RTT in the network as a state of the network.

### (Supplementary Note 10)

The network state estimation apparatus according to any one of Supplementary Notes 6 to 9, further including a reception interval calculation unit configured to calculate a reception interval between the first received packet and the second received packet on the basis of a transmission interval of a transmission packet for the first received packet and the second received packet, an RTT of the first received packet, and an RTT of the second received packet.

### (Supplementary Note 11)

A network state estimation system including:
a round trip time (RTT) acquisition unit configured to acquire an RTT of each of a first received packet and a second received packet received via a network;
a difference calculation unit configured to calculate an RTT difference that is a difference between the RTT of the first received packet and the RTT of the second received packet;
a filtering unit configured to perform smoothing on the RTT difference by using a plurality of stages of Kalman filters connected in series with each other;
a threshold specifying unit configured to specify a threshold for an output of a final stage of Kalman filter among the plurality of stages of Kalman filters on the basis of an output of a first stage of Kalman filter among the plurality of stages of Kalman filters; and
a state estimation unit configured to compare the output of the final stage of Kalman filter among the plurality of stages of Kalman filters with the specified threshold and to estimate a state of the network on the basis of the comparison result.

### (Supplementary Note 12)

The network state estimation system according to Supplementary Note 11,
wherein the threshold specifying unit,
calculates a candidate threshold that is a candidate for the threshold at the time of receiving the second received packet on the basis of the threshold at the time of receiving the first received packet, and an output of the first stage of Kalman filter that has performed smoothing on the RTT difference,
calculates a maximum value between the calculated candidate threshold and a predetermined lower limit value, and
specifies the calculated maximum value as the threshold at the time of receiving the second received packet.

### (Supplementary Note 13)

The network state estimation system according to Supplementary Note 12, wherein the lower limit value is set on the basis of a scheduling characteristic of the network.

### (Supplementary Note 14)

The network state estimation system according to any one of Supplementary Notes 11 to 13, wherein the state estimation unit estimates a state of increase or decrease of the RTT in the network as a state of the network.

### (Supplementary Note 15)

The network state estimation system according to any one of Supplementary Notes 11 to 14, further including a reception interval calculation unit configured to calculate a reception interval between the first received packet and the second received packet on the basis of a transmission interval of a transmission packet for the first received packet and the second received packet, an RTT of the first received packet, and an RTT of the second received packet.

### REFERENCE SIGNS LIST

100 NETWORK STATE ESTIMATION APPARATUS
101 RTT ACQUISITION UNIT
102 DIFFERENCE CALCULATION UNIT
103 FILTERING UNIT
1031-1 to 1031-N KALMAN FILTER
104 THRESHOLD SPECIFYING UNIT
105 STATE ESTIMATION UNIT
100A NETWORK STATE ESTIMATION SYSTEM
10, 10A NETWORK STATE ESTIMATION APPARATUS
11 SRTT ACQUISITION UNIT
12 DIFFERENCE CALCULATION UNIT
13 FILTERING UNIT
131-1 to 131-2 KALMAN FILTER
14 THRESHOLD SPECIFYING UNIT
STATE ESTIMATION UNIT
16 RECEPTION INTERVAL CALCULATION UNIT
90 COMPUTER
91 PROCESSOR
92 MEMORY
93 STORAGE
94 INPUT/OUTPUT INTERFACE
941 DISPLAY APPARATUS
942 INPUT APPARATUS
943 SOUND OUTPUT APPARATUS
95 COMMUNICATION INTERFACE

What is claimed is:

1. A network state estimation method comprising:
a round trip time (RTT) acquisition step of acquiring an RTT of each of a first received packet and a second received packet received via a network;
a difference calculation step of calculating an RTT difference that is a difference between the RTT of the first received packet and the RTT of the second received packet;
a filtering step of performing smoothing on the RTT difference by using a plurality of stages of Kalman filters connected in series with each other;
a threshold specifying step of specifying a threshold for an output of a final stage of Kalman filter among the plurality of stages of Kalman filters on the basis of an output of a first stage of Kalman filter among the plurality of stages of Kalman filters; and
a state estimation step of comparing the output of the final stage of Kalman filter among the plurality of stages of Kalman filters with the specified threshold and estimating a state of the network on the basis of the comparison result.

2. The network state estimation method according to claim 1,
wherein in the threshold specifying step,
a candidate threshold that is a candidate for the threshold at the time of receiving the second received packet is calculated on the basis of the threshold at the time of receiving the first received packet, and an output of the first stage of Kalman filter that has performed smoothing on the RTT difference,
a maximum value between the calculated candidate threshold and a predetermined lower limit value is calculated, and
the calculated maximum value is specified as the threshold at the time of receiving the second received packet.

3. The network state estimation method according to claim 2, wherein the lower limit value is set on the basis of a scheduling characteristic of the network.

4. The network state estimation method according to claim 1, wherein in the state estimation step, a state of increase or decrease of the RTT in the network is estimated as a state of the network.

5. The network state estimation method according to claim 1, further comprising a reception interval calculation step of calculating a reception interval between the first received packet and the second received packet on the basis of a transmission interval of a transmission packet for the first received packet and the second received packet, an RTT of the first received packet, and an RTT of the second received packet.

6. A network state estimation apparatus comprising:
at least one memory storing instructions, and
at least one processor configured to execute the instructions to;
of each of a first received packet and a second received packet received via a network;
calculate an RTT difference that is a difference between the RTT of the first received packet and the RTT of the second received packet;
perform smoothing on the RTT difference by using a plurality of stages of Kalman filters connected in series with each other;
specify a threshold for an output of a final stage of Kalman filter among the plurality of stages of Kalman filters on the basis of an output of a first stage of Kalman filter among the plurality of stages of Kalman filters; and
compare the output of the final stage of Kalman filter among the plurality of stages of Kalman filters with the specified threshold and to estimate a state of the network on the basis of the comparison result.

7. The network state estimation apparatus according to claim 6,
wherein the at least one processor is further configured to execute the instructions to,
calculate a candidate threshold that is a candidate for the threshold at the time of receiving the second received packet on the basis of the threshold at the time of receiving the first received packet, and an output of the first stage of Kalman filter that has performed smoothing on the RTT difference,
calculate a maximum value between the calculated candidate threshold and a predetermined lower limit value, and
specify the calculated maximum value as the threshold at the time of receiving the second received packet.

8. The network state estimation apparatus according to claim 7, wherein the lower limit value is set on the basis of a scheduling characteristic of the network.

9. The network state estimation apparatus according to claim 6, wherein the at least one processor is further configured to execute the instructions to estimate the state estimation unit estimates a state of increase or decrease of the RTT in the network as a state of the network.

10. The network state estimation apparatus according to claim 6, wherein the at least one processor is further configured to execute the instructions to calculate a reception interval between the first received packet and the second received packet on the basis of a transmission interval of a transmission packet for the first received packet and the second received packet, an RTT of the first received packet, and an RTT of the second received packet.

11. A network state estimation system, comprising:
at least one memory storing instructions, and
at least one processor configured to execute the instructions to;
acquire a round trip time (RTT) of each of a first received packet and a second received packet received via a network;
calculate an RTT difference that is a difference between the RTT of the first received packet and the RTT of the second received packet;
perform smoothing on the RTT difference by using a plurality of stages of Kalman filters connected in series with each other;
specify a threshold for an output of a final stage of Kalman filter among the plurality of stages of Kalman filters on the basis of an output of a first stage of Kalman filter among the plurality of stages of Kalman filters; and
compare the output of the final stage of Kalman filter among the plurality of stages of Kalman filters with the specified threshold and to estimate a state of the network on the basis of the comparison result.

12. The network state estimation system according to claim 11,
wherein the at least one processor is further configured to execute the instructions to,
calculate a candidate threshold that is a candidate for the threshold at the time of receiving the second received packet on the basis of the threshold at the time of receiving the first received packet, and an output of the first stage of Kalman filter that has performed smoothing on the RTT difference,
calculate a maximum value between the calculated candidate threshold and a predetermined lower limit value, and
specify the calculated maximum value as the threshold at the time of receiving the second received packet.

13. The network state estimation system according to claim 12, wherein the lower limit value is set on the basis of a scheduling characteristic of the network.

14. The network state estimation system according to claim 11, wherein the at least one processor is further configured to execute the instructions to estimate a state of increase or decrease of the RTT in the network as a state of the network.

15. The network state estimation system according to claim 11, wherein the at least one processor is further configured to execute the instructions to calculate a reception interval between the first received packet and the second received packet on the basis of a transmission interval of a transmission packet for the first received packet and the second received packet, an RTT of the first received packet, and an RTT of the second received packet.
